(19) United States
(12) Patent Application Publication
(10) Pub. No.: US 2018/0332814 A1
(43) Pub. Date: Nov. 22, 2018

(54) SYSTEM AND METHOD OF TRANSFERRING A CULTURED ORGANISM BETWEEN CULTURE CONTAINERS

(71) Applicant: DROBOT BIOTECHNOLOGY LIMITED COMPANY, Taipei (TW)

(72) Inventor: Chia-Kang TSAO, Taipei (TW)

(73) Assignee: DROBOT BIOTECHNOLOGY LIMITED COMPANY, Taipei (TW)

(21) Appl. No.: 15/869,243

(22) Filed: Jan. 12, 2018

Related U.S. Application Data
(60) Provisional application No. 62/509,719, filed on May 22, 2017.

(51) Int. Cl. A01K 1/00; A61D 7/04

(52) U.S. Cl. CPC A01K 1/0035; B25J 11/00; A01K 2227/706; A61D 7/04

(57) ABSTRACT

A transfer system includes a first and a second processing region, a support base, an anesthetization unit and a cover handling unit. The support base can provide support for a plurality of culture containers in the first and second processing regions, each culture container including a tube having two openings and a removable cover installable to close one of the two openings of the tube, the first and second processing regions being adapted to interchangeably receive the tubes of the culture containers. The anesthetization unit is operable to deliver an anesthetic substance into at least one culture container positioned in the first processing region. The cover handling unit is operable to separate the covers from the tubes and close the openings of the tubes with the covers in the first and second processing regions. Moreover, embodiments described herein provide a method of transferring a cultured organism with the transfer system.

### CROSS-REFERENCE TO RELATED APPLICATION(S)

This application claims priority to U.S. Provisional Patent Application No. 62/509,719 filed on May 22, 2017, the disclosure of which is entirely incorporated herein by reference.

### BACKGROUND

### 1. Field of the Invention

The present invention relates to culture containers, and systems and methods of transferring a cultured organism between culture containers.

### 2. Description of the Related Art

Drosophila species, such as Drosophila melanogaster (also known as fruit flies), have been extensively used in genetic research and is a common model organism in biology studies. Cultures of fruit flies are usually made in vials or bottles. For maintaining stocks of the fruit flies for a long period of time, the cultures of fruit flies have to be periodically transferred to new vials or bottles. This transfer process may be challenging to achieve for large-scale cultures involving thousands of stocks, wherein the cultured organism in each vial or bottle has to be transferred to a clean new vial or bottle without introducing contaminants that may alter the cultured stock.

Some existing equipment may use robot arms to facilitate the transfer process. For example, for transferring a culture of fruit flies from one vial to a new vial, the transfer process includes stunning the fruit flies, opening the two vials, using the robot arms to position the two vials so that their respective openings are in close contact with each other, and transferring the fruit flies from the current vial to the new vial. This approach may be time-consuming and require a sophisticated control, e.g., for properly positioning the vials so that the fruit flies can be transferred without introducing contaminants, or without fruit flies dropping outside the vials, which may contaminate subsequently processed vials.

Therefore, there is a need for a design that can achieve the transfer process in a more efficient manner, and address or improve at least the foregoing issues.

### SUMMARY

The present application describes a system and a method of transferring a cultured organism between culture containers.

A transfer system described herein includes a first and a second processing region, a support base, an anesthetization unit and a cover handling unit. The support base is suitable to provide support for a plurality of culture containers positioned in the first and second processing regions, each of the culture containers including a tube having a first and a second opening at two opposite ends thereof and a removable cover installable to close the first opening of the tube, the first and second processing regions being adapted to interchangeably receive the tubes of the culture containers. The anesthetization unit is operable to deliver an anesthetic substance into at least one culture container positioned in the first processing region. The cover handling unit is operable to separate the covers from the tubes and close the first openings of the tubes with the covers in the first and second processing regions.

Moreover, the present application describes a method of transferring a cultured organism of interest through a transfer system that includes an anesthetization unit and a cover handling unit. The method includes positioning a first culture container enclosing an organism of interest in a first processing region of the transfer system, and a second culture container enclosing no organism of interest in a second processing region of the transfer system. The first culture container includes a first tube having two openings at two opposite ends thereof, and a first cover and a first air-permeable plug respectively closing the two openings of the first tube, the first cover including a first receptacle holding a substance consumable by the organism and new generations of the organism, the first receptacle being enclosed inside the first tube. The second culture container includes a second tube having two openings at two opposite ends thereof, and a second cover and a second air-permeable plug respectively closing the two openings of the second tube, the second cover including a second receptacle holding a substance consumable by the organism, the second receptacle being enclosed inside the second tube.

The method further includes delivering an anesthetic substance into the first tube with the anesthetization unit, respectively removing the first cover from the first tube and the second cover from the second tube with the cover handling unit, swapping the first tube having the first cover removed therefrom with the second tube having the second cover removed therefrom so that the first tube is positioned in the second processing region and the second tube is positioned in the first processing region, and through the cover handling unit, closing the first tube in the second processing region with the second cover, and closing the second tube in the first processing region with the first cover.

### BRIEF DESCRIPTION OF THE DRAWINGS

FIG. 1 is a side view illustrating an embodiment of a culture container;

FIG. 2 is an exploded view of the culture container;

FIG. 3 is a side view illustrating a variant construction of a culture container;

FIG. 4 is a schematic view illustrating exemplary use of the culture container 100 for culturing and maintaining a population of an organism of interest;

FIG. 5 is a perspective view illustrating a transfer system operable to transfer a cultured organism of interest between a plurality of culture containers;

FIG. 6 is a front view of the transfer system shown in FIG. 5;

FIG. 7 is a side view of the transfer system shown in FIG. 5;

FIG. 8 is a top view schematically illustrating some construction details of a support base provided in the transfer system;

FIG. 9 is a top view schematically illustrating some construction details of a clamping unit provided in the transfer system;

FIG. 10 is a flowchart illustrating method steps executable by the transfer system for transferring an organism of interest between multiple culture containers;

FIGS. 11-23 are simplified views schematically illustrating various intermediate states of the transfer system during an implementation of the method steps; and

FIGS. 24 and 25 are schematic views illustrating culture containers after the transfer is completed.

### DETAILED DESCRIPTION OF THE EMBODIMENTS

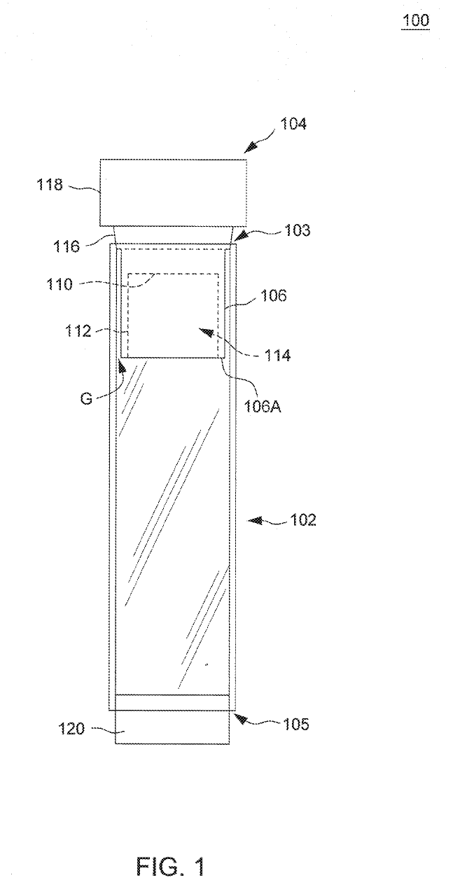

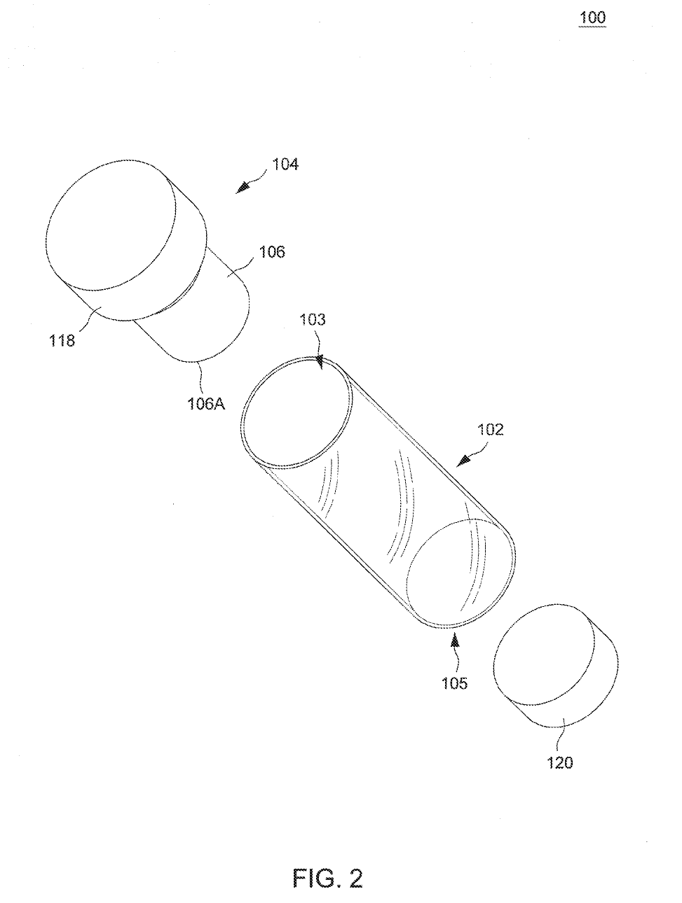

Embodiments described herein provide culture containers and systems and method that can facilitate the transfer of an organism of interest grown inside the culture containers. FIG. 1 is a side view illustrating an embodiment of a culture container 100, and FIG. 2 is an exploded view of the culture container 100. The culture container 100 can be used for culturing and maintaining a population of an organism of interest. Examples of organisms that may be grown and maintained inside the culture container 100 may include, without limitation, drosophila species such as fruit flies, or any other insects that may be used as experimental models. Referring to FIGS. 1 and 2, the culture container 100 can include a tube 102 and a removable cover 104. The tube 102 may have any suitable shapes. Examples of shapes for the tube 102 can include, without limitation, a generally cylindrical shape (as shown), a truncated conical shape, a prismatic shape, etc. The tube 102 has a hollow interior, and two openings 103 and 105 respectively at two opposite ends that communicate with the hollow interior of the tube 102. To facilitate observation of an organism of interest enclosed inside the culture container 100, the tube 102 may be made of a transparent material, such as transparent glass or plastic.

The cover 104 is attachable to and removable from the opening 103 of the tube 102. The cover 104 includes a receptacle 106. The receptacle 106 can be disposed at an inner side of the cover 104 oriented toward the tube 102, and can be configured to hold a substance consumable by an organism of interest, such as nutritive substance, a drug substance and the like. According to an example of construction, the receptacle 106 may include a base surface 110 and a surrounding wall 112 connected with each other for at least partially delimiting a cavity 114 suitable for receiving the consumable substance. When the cover 104 is attached to and closes the opening 103 of the tube 102, the receptacle 106 is enclosed inside the tube 102 with the surrounding wall 112 protruding from the base surface 110 toward the other opening 105 of the tube 102.

Any suitable technique may be applied to facilitate the attachment of the cover 104 on the tube 102. According to an embodiment, the cover 104 may be attached to the tube 102 by interference fit between the cover 104 and the tube 102. For example, with reference to FIG. 1, the cover 104 may include a coupling portion 116 that may be in frictional contact with an inner surface of the tube 102 when the cover 104 is assembled to close the opening 103. The coupling portion 116 can be exemplary inserted into the opening 103 in frictional contact with an inner surface region of the tube 102 adjacent to the opening 103. For facilitating installation and removal of the cover 104 on the tube 102, the frictional contact between the cover 104 and the tube 102 can be achieved on a tapered shape provided on the coupling portion 116 of the cover 104.

Referring to FIG. 1, when the cover 104 is attached to the tube 102, there may be a gap G between an inner sidewall surface of the tube 102 and the receptacle 106, the gap G extending along a height of the receptacle 106 to an end rim 106A of the receptacle 106. The tube 102 and the receptacle 106 can be dimensioned so that the gap G (especially at the end rim 106A of the receptacle 106) is sufficiently small to prevent passage of a cultured organism in the gap G.

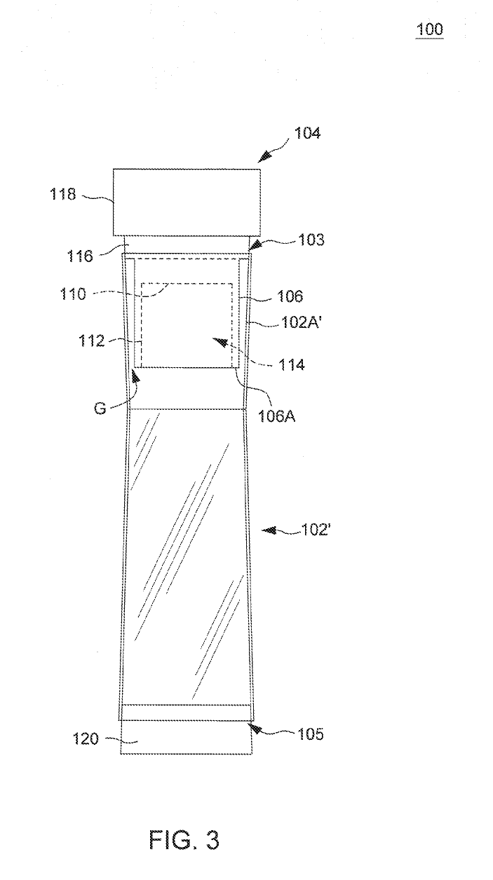

FIG. 3 is a side view illustrating a variant construction in which the tube 102′ may have a tapered portion 102A′ adjacent to the receptacle 106 of the cover 104. The gap G can be defined between an inner sidewall of the tapered portion 102A′ and the receptacle 106. Owing to the tapered portion 102A′, the gap G may increasingly reduce toward the end rim 106A of the receptacle 106. In this manner, the gap G can be smallest at the end rim 106A to prevent passage of a cultured organism.

Referring to FIGS. 1-3, the cover 104 may further include a catch portion 118 that can project laterally from an outer side surface of the tube 102 when the cover 104 is attached to the tube 102. The catch portion 118 may extend continuously along a circumference of the cover 104, or may project locally on a periphery of the cover 104. The catch portion 118 can facilitate grasping of the cover 104 for installation and removal of the cover 104 on the tube 102.

Referring again to FIGS. 1-3, the culture container 100 may further include an air-permeable plug 120 that may be detachably installed to close the opening 105 of the tube 102. The air-permeable plug 120 can prevent the cultured organism of interest from escaping the culture container 100 through the opening 105 of the tube 102 while allowing air passage for breathing of the cultured organism. The air-permeable plug 120 can include a breathable material. Examples of materials for the air-permeable plug 120 may include, without limitation, cotton, breathable fibers, porous or perforate materials, and the like.

According to at least an embodiment, the culture container 100 described herein may be implemented as a culture vial having an elongate shape. For example, the tube 102 may have a length between about 5 cm and about 20 cm. The tube 102 may further exemplary have a radius between about 0.5 cm and about 6 cm. The cover 104 may have a height between about 1 cm and about 10 cm. Moreover, the cover 104 may have a radius between about 0.5 cm and about 6 cm.

However, it will be appreciated that the culture container 100 is not limited to vial embodiments, and may take other forms. For example, the culture container 100 described herein may also be implemented as a culture bottle for growing a greater population of the organism of interest.

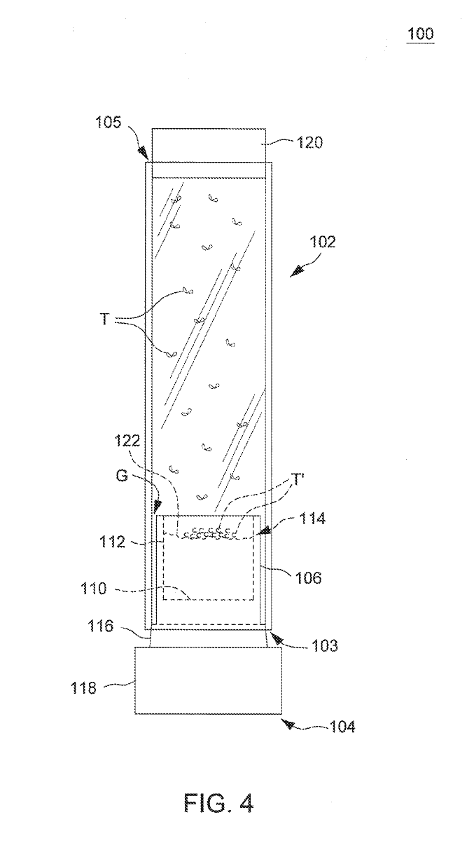

FIG. 4 is a schematic view illustrating exemplary use of the culture container 100 for culturing and maintaining a population of an organism of interest T. Examples of the organism T may include, without limitation, fruit flies or any other insects of interest. The organism enclosed in the culture container 100 may include an adult form and a non-adult form, such as eggs, larvae and/or pupae. The culture container 100 may be used to culture a population of the organism T with the cover 104 closing the opening 103 of the tube 102 and the air-permeable plug 120 closing the opening 105 of the tube 102 opposite to the cover 104. The receptacle 106 of the cover 104 may retain a substance 122 consumable by the organism of interest T that is grown and enclosed inside the culture container 100. The consumable substance 122 may include, without limitation, a nutritive substance, a drug substance and the like. In addition, the receptacle 106 of the cover 104 may receive new generations T′ of the organism, which may include, without limitation, a non-adult form of the organism such as eggs, larvae and/or pupae. For example, the new generations T′ of the organism may adhere to the consumable substance 122 and/or the wall 112 of the receptacle 106. To facilitate air passage through the air-permeable plug 120 into the culture container 100, the culture container 100 may be disposed with the cover 104 at the bottom and the air-permeable plug 120 on top while culturing the organism T.

As the organism T is cultured inside the culture container 100 over a period of time, new generations T′ of the organism as well as dead organic matter may accumulate inside the culture container 100. As a result, a transfer to a new culture container may be needed for continuing the culture of the organism T.

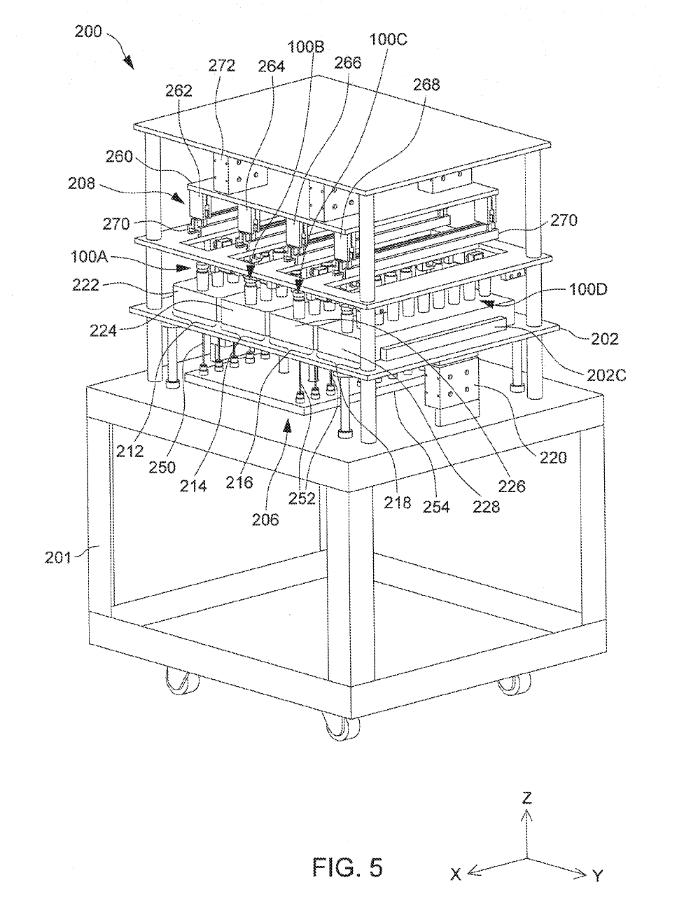

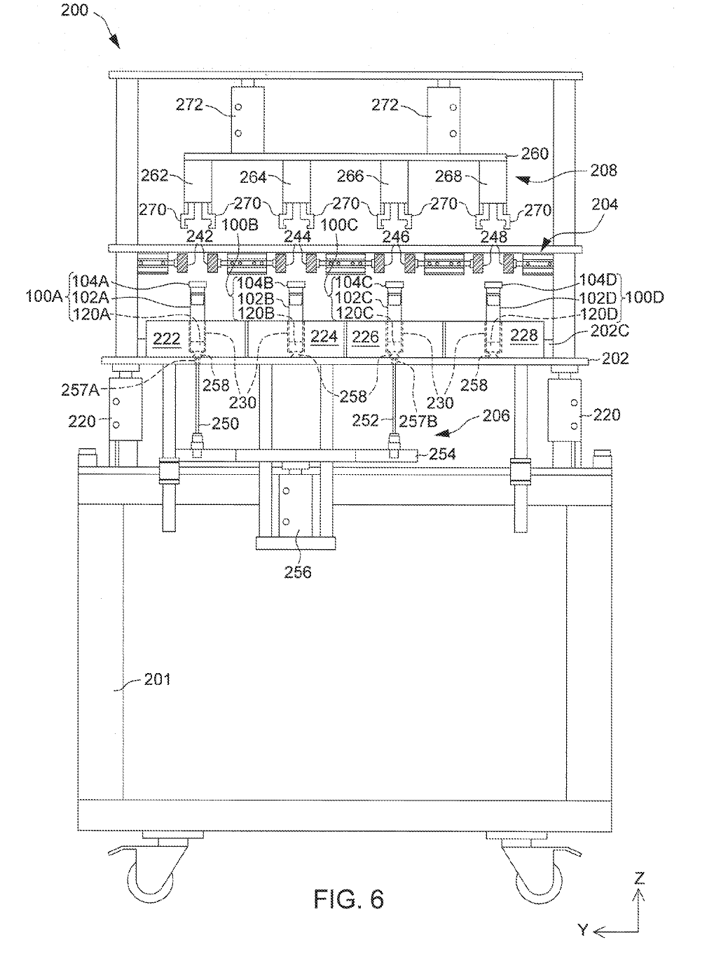

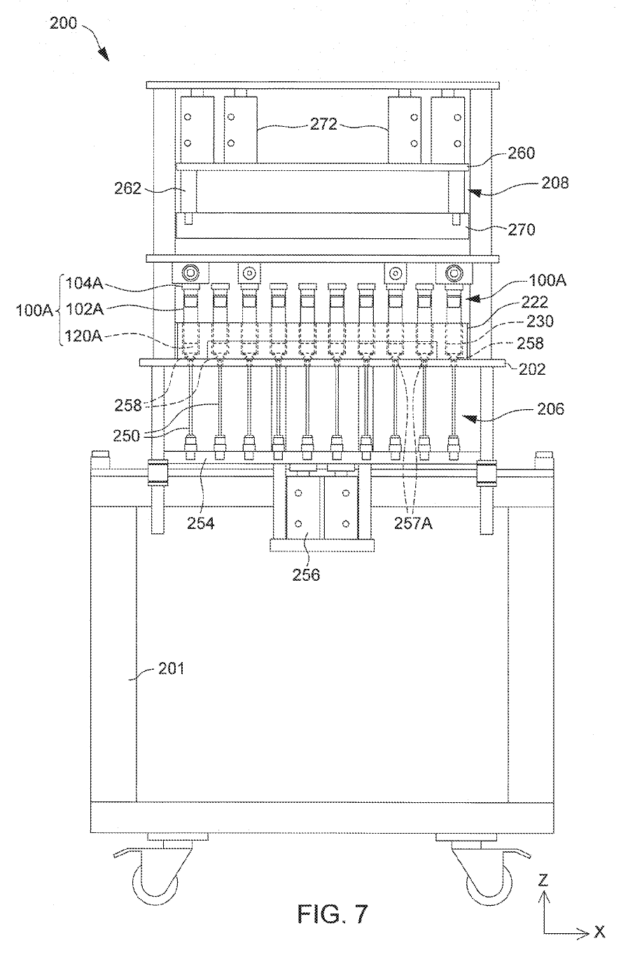

FIG. 5 is a perspective view illustrating a transfer system 200 operable to transfer a cultured organism of interest between a plurality of culture containers 100A and 100B and between a plurality of culture containers 100C and 100D, FIG. 6 is a front view of the transfer system 200, and FIG. 7 is a side view of the transfer system 200. Referring to FIGS. 5-7, the transfer system 200 can include a machine frame 201, support base 202, a clamping unit 204, an anesthetization unit 206 and a cover handling unit 208.

The support base 202 can be assembled with the machine frame 201, and can provide support for a plurality of culture containers disposed in a plurality of processing regions 212, 214, 216 and 218 of the transfer system 200. The processing regions 212, 214, 216 and 218 are configured to interchangeably receive the culture containers disposed in rows parallel to one another for processing. For example, as illustrated in FIGS. 5-7, a row of the culture containers 100A can be placed in the processing region 212, a row of the culture containers 100B can be placed in the processing region 214, a row of the culture containers 100C can be placed in the processing region 216, and a row of the culture containers 100D can be placed in the processing region 218.

Although the embodiment depicted herein exemplary has four processing regions 212, 214, 216 and 218, it will be appreciated that the transfer system 200 may be configured to have any number of processing regions in accordance with the quantity of culture containers to process. For example, other embodiments of the transfer system 200 may include two processing regions, four processing regions, six processing regions, or any even number of processing regions.

Each of the culture containers 100A, 100B, 100C and 100D processed by the transfer system 200 can be identical to the culture container 100 described previously. For example, each culture container 100A can include a tube 102A having two opposite openings respectively closed with a cover 104A and an air-permeable plug 120A, each culture container 100B can include a tube 102B having two opposite openings respectively closed with a cover 104B and an air-permeable plug 120B, each culture container 100C can include a tube 102C having two opposite openings respectively closed with a cover 104C and an air-permeable plug 120C, and each culture container 100D can include a tube 102D having two opposite openings respectively closed with a cover 104D and an air-permeable plug 120D.

According to an embodiment, the support base 202 may be movably assembled with the machine frame 201 for sliding movement along a vertical axis Z to facilitate processing of the culture containers disposed thereon. For example, the support base 202 may be connected with one or more actuator 220 operable to displace the support base 202 up and down along the vertical axis Z. Examples of the actuators 220 can include pneumatic actuators, hydraulic actuators, motorized actuators, and the like.

For facilitating the handling of the culture containers 100A, 100B, 100C and 100D, the transfer system 200 can further include a plurality of container carriers 222, 224, 226 and 228 that may be placed in the transfer system 200 and removed therefrom. The container carriers 222, 224, 226 and 228 can be identical in size and construction. Each of the container carriers 222, 224, 226 and 228 may exemplary take the form of a tray, and can have a row of cavities 230 adapted to receive the tubes of the culture containers. For example, as illustrated in FIGS. 6, the cavities 230 of the container carrier 222 can receive the tubes 102A of the culture containers 100A, the cavities 230 of the container carrier 224 can receive the tubes 102B of the culture containers 100B, the cavities 230 of the container carrier 226 can receive the tubes 102C of the culture containers 100C, and the cavities 230 of the container carrier 228 can receive the tubes 102D of the culture containers 100D. The container carriers 222, 224, 226 and 228 can be installed on the support base 202, and can be interchangeably positionable in the processing regions 212, 214, 216 and 218.

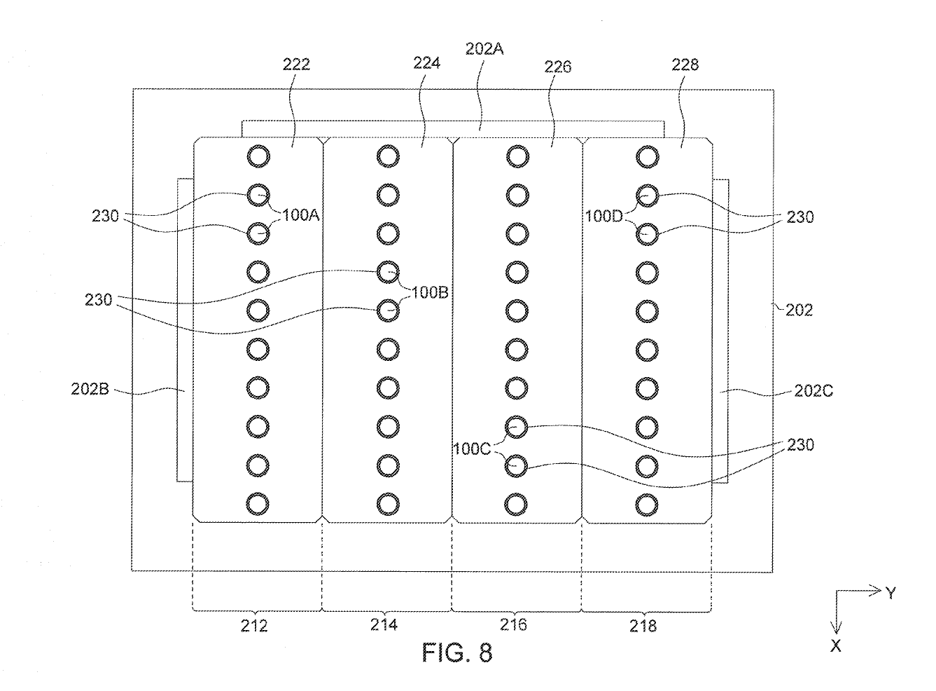

In conjunction with FIGS. 5-7, FIG. 8 is a top view schematically illustrating the support base 202. Referring to FIGS. 5-8, the support base 202 can include a plurality of stop structures 202A, 202B and 202C for assisting with positioning of the container carriers 222, 224, 226 and 228 in the processing regions 212, 214, 216 and 218. For example, the stop structure 202A can be a protruding rib extending across the processing regions 212, 214, 216 and 218, and can stop the container carriers 222, 224, 226 and 228 in one direction along a horizontal axis X. The stop structures 202B and 202C can be two protruding ribs respectively disposed adjacent to the two outermost ones of the processing regions 212, 214, 216 and 218, i.e., the processing regions 212 and 218, and can stop the container carriers 222, 224, 226 and 228 in two opposite directions along another horizontal axis Y perpendicular to the axis X.

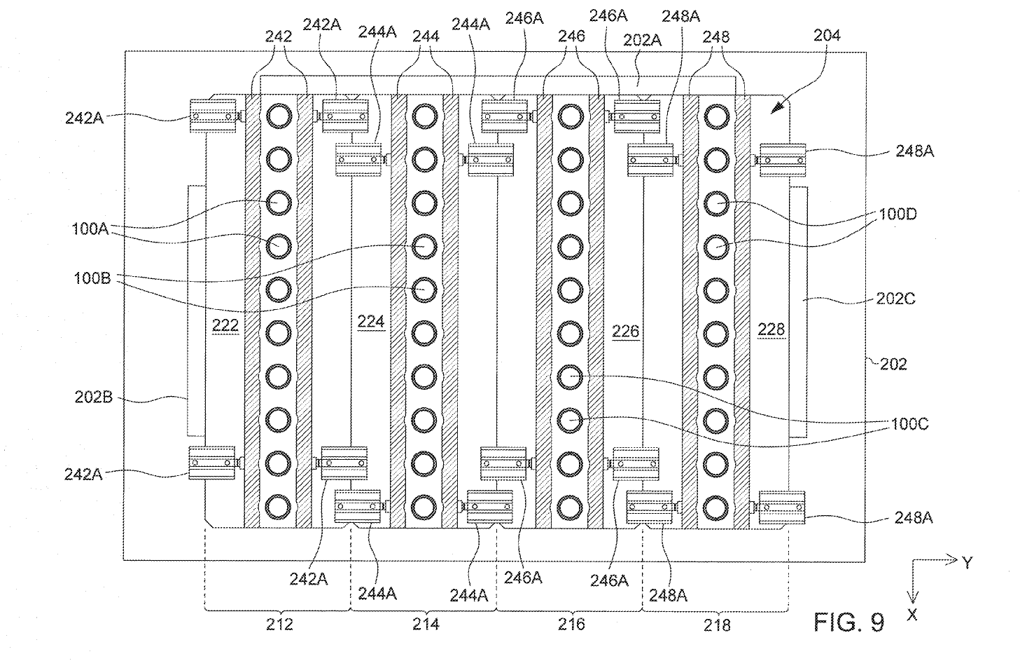

In conjunction with FIGS. 5-7, FIG. 9 is a top view schematically illustrating some construction details of the clamping unit 204. Referring again to FIGS. 5-7 and 9, the clamping unit 204 is operable to hold and release the tubes of the culture containers in the processing regions 212, 214, 216 and 218. For example, the clamping unit 204 can include a plurality of clamping plates 242, 244, 246 and 248 disposed above the support base 202 respectively adjacent to the processing regions 212, 214, 216 and 218. More specifically, the two clamping plates 242 can move toward and away from each other to hold and release the tubes 102A of the culture containers 100A disposed in a row in the processing region 212. The two clamping plates 244 can move toward and away from each other to hold and release the tubes 102B of the culture containers 100B disposed in a row in the processing region 214. The two clamping plates 246 can move toward and away from each other to hold and release the tubes 102C of the culture containers 100C disposed in a row in the processing region 216. The two clamping plates 248 can move toward and away from each other to hold and release the tubes 102D of the culture containers 100D disposed in a row in the processing region 218.

The clamping unit 204 can further include a plurality of actuators operable to actuate the clamping plates. For example, the two clamping plates 242 can be connected with actuators 242A operable to displace the clamping plates 242 toward and away from each other. The two clamping plates 244 can be connected with actuators 244A operable to displace the clamping plates 244 toward and away from each other. The two clamping plates 246 can be connected with actuators 246A operable to displace the clamping plates 246 toward and away from each other. The two clamping plates 248 can be connected with actuators 248A operable to displace the clamping plates 248 toward and away from each other. Examples of the actuators 242A, 244A, 246A and 248A can include pneumatic actuators, hydraulic actuators, motorized actuators, and the like.

Referring to FIGS. 5-7, the anesthetization unit 206 is operable to deliver an anesthetic substance into culture containers in selective ones of the processing regions 212, 214, 216 and 218, e.g., the two processing regions 212 and 216. Examples of suitable anesthetic substances include dioxide carbon gas. According to an embodiment, the anesthetization unit 206 can include a plurality of nozzles 250 and 252 and a support frame 254. Each of the nozzles 250 and 252 can have a needle shape. The nozzles 250 can be disposed in a row adjacent to the processing region 212, and can be affixed with the support frame 254. The nozzles 250 can respectively deliver an anesthetic substance from an underside of the support base 202 into culture containers enclosing an organism that are positioned on the support base 202 in the processing region 212. For example, as illustrated in FIGS. 5-7, the nozzles 250 can respectively deliver an anesthetic substance through the air-permeable plugs 120A into the tubes 102A of the culture containers 100A positioned on the support base 202 in the processing region 212. The nozzles 252 can be disposed in a row adjacent to the processing region 216 that is parallel to the row of the nozzles 250, and can be affixed with the support frame 254. Likewise, the nozzles 252 can respectively deliver an anesthetic substance from an underside of the support base 202 into culture containers enclosing an organism that are positioned on the support base 202 in the processing region 216. For example, as illustrated in FIGS. 5-7, the nozzles 252 can respectively deliver an anesthetic substance through the air-permeable plugs 120C into the tubes 102C of the culture containers 100C positioned on the support base 202 in the processing region 216.

According to an embodiment, the anesthetization unit 206 may further include an actuator 256 operable to displace the nozzles 250 and 252 toward and away from the culture containers placed in the processing regions 212 and 216. The actuator 256 can be connected with the support frame 254, and is operable to vertically displace the support frame 254 and the nozzles 250 and 252. For example, the actuator 256 can concurrently displace the support frame 254 and the nozzles 250 and 252 upward so that the nozzles 250 and 252 respectively insert into the tubes 102A and 102C of the culture containers 100A and 100C in the processing regions 212 and 216 for injecting the anesthetic substance therein, and concurrently displace the support frame 254 and the nozzles 250 and 252 downward for removing the nozzles 250 and 252 from the tubes 102A and 102C of the culture containers 100A and 100C.

For facilitating the delivery of the anesthetic substance into the culture containers, the support base 202 can include a plurality of openings 257A and 257B for passage of the nozzles 250 and 252. Moreover, each of the container carriers 222, 224, 226 and 228 can have a bottom surface provided with a plurality of holes 258 that are respectively connected with the cavities 230. The nozzles 250 of the anesthetization unit 206 can respectively travel through the openings 257A of the support base 202 and the holes 258 of the container carrier 222 positioned in the processing region 212 and then insert into the culture containers 100A carried by the container carrier 222 for introducing an anesthetic substance therein. Likewise, the nozzles 252 of the anesthetization unit 206 can respectively travel through the openings 257B of the support base 202 and the holes 258 of the container carrier 226 positioned in the processing region 216 and then insert into the culture containers 100C carried by the container carrier 226 for introducing an anesthetic substance therein.

With the aforementioned construction, the anesthetization unit 206 can concurrently deliver an anesthetic substance into all of the culture containers 100A disposed in a row in the processing region 212 and all the culture containers 100C disposed in a row in the processing region 216. According to an example of implementation, the anesthetization unit 206 may deliver the anesthetic substance into the culture containers 100A and 100C while the tubes 102A and 102C thereof are respectively held by the clamping unit 204 in the processing regions 212 and 216.

Referring again to FIGS. 5-7, the cover handling unit 208 may be disposed vertically above the support base 202 and the anesthetization unit 206. The cover handling unit 208 is operable to separate a cover from a tube and close a tube with a cover for each of the culture containers disposed in the processing regions 212, 214, 216 and 218. According to an embodiment, the cover handling unit 208 can include a support frame 260, and a plurality of arms 262, 264, 266 and 268 respectively attached to the support frame 260. The arm 262 can be disposed adjacent to the processing region 212, the arm 264 can be disposed adjacent to the processing region 214, the arm 266 can be disposed adjacent to the processing region 216, and the arm 268 can be disposed adjacent to the processing region 218. Each of the arms 262, 264, 266 and 268 can respectively include a plurality of movable fingers 270 operable to grasp and hold multiple covers or release the covers of the culture containers disposed along a row.

The cover handling unit 208 can further include one or more actuator 272 connected with the support frame 260. The actuator 272 is operable to concurrently displace the support frame 260 and the arms 262, 264, 266 and 268 along the vertical axis Z. For example, the actuator 272 can concurrently displace the support frame 260 and the arms 262, 264, 266 and 268 downward so that the fingers 270 thereof can respectively hold the covers of the culture containers aligned in rows in the processing regions 212, 214, 216 and 218, and then concurrently displace the support frame 260 and the arms 262, 264, 266 and 268 upward while the arms 262, 264, 266 and 268 hold the covers, whereby the covers can be separated from the tubes in a concurrent manner and respectively kept along parallel rows in the processing regions 212, 214, 216 and 218. Moreover, the actuator 272 can concurrently displace the support frame 260 and the arms 262, 264, 266 and 268 downward while the arms 262, 264, 266 and 268 hold the covers, whereby the covers can be installed to close the tubes aligned in rows in the processing regions 212, 214, 216 and 218 in a concurrent manner.

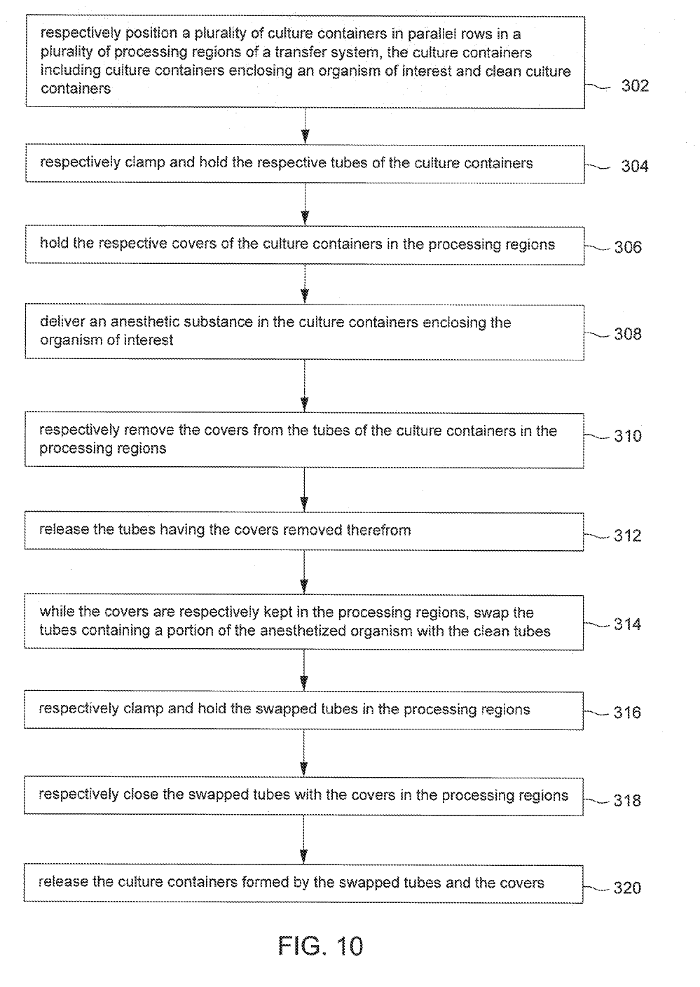

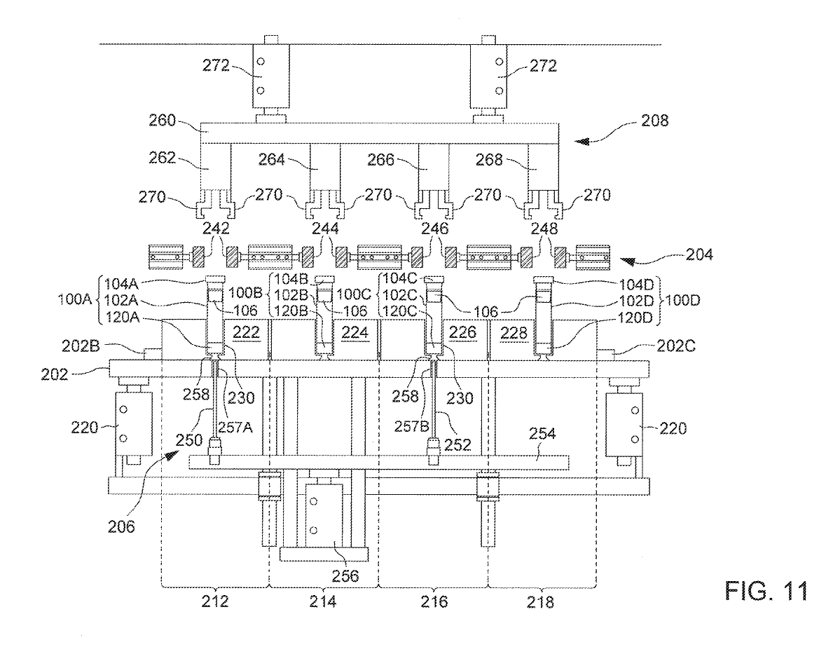

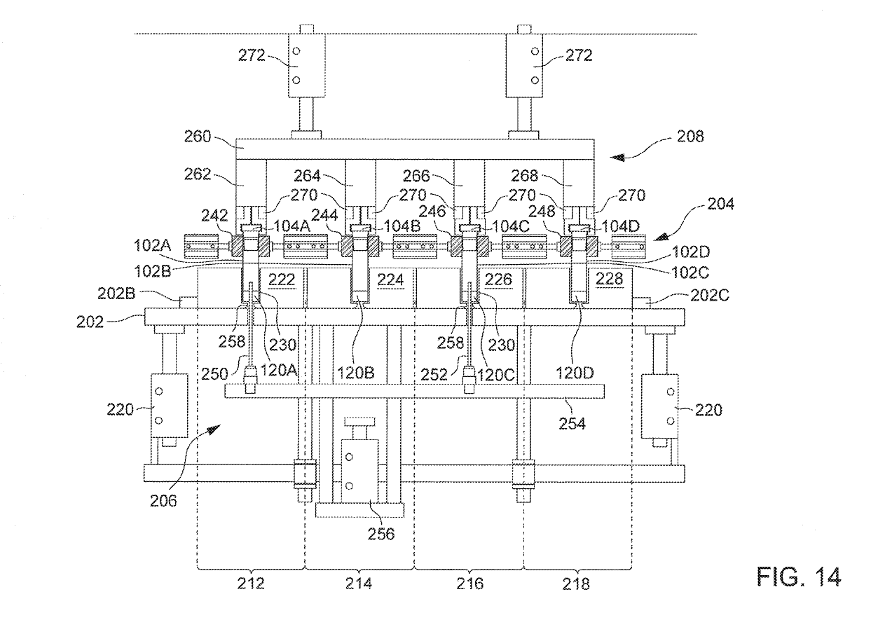

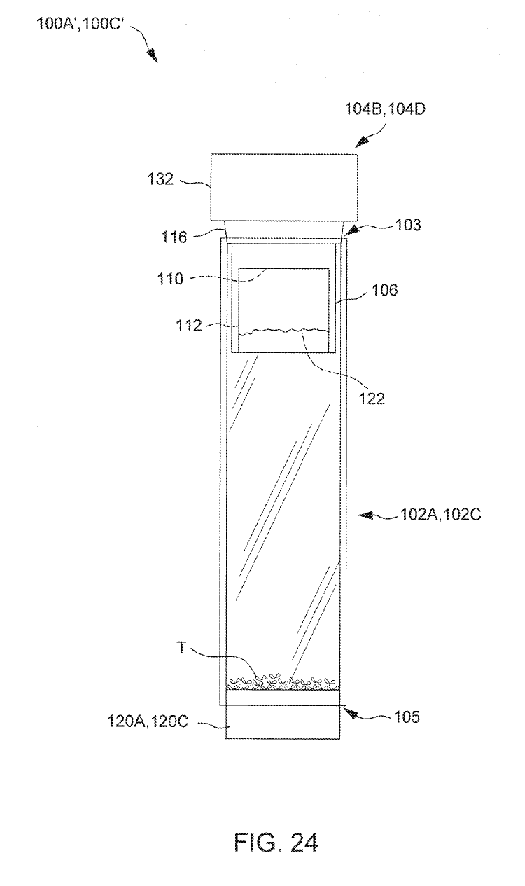

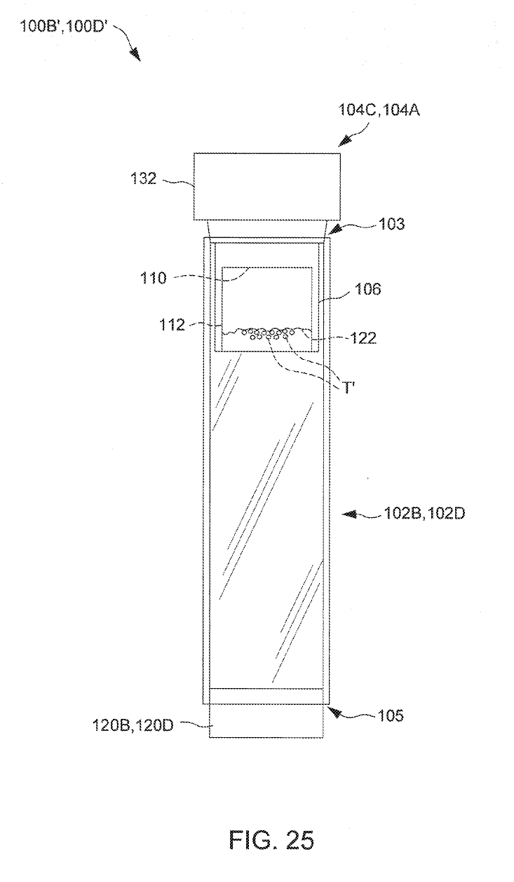

In conjunction with FIGS. 1-9, reference is made hereinafter to FIGS. 10-25 to describe a method of transferring a cultured organism of interest with the transfer system 200. More specifically, FIG. 10 is a flowchart illustrating method steps executable by the transfer system 200 for transferring an organism of interest between multiple culture containers 100A, 100B, 100C and 100D, FIGS. 11-23 are simplified views schematically illustrating various intermediate states of the transfer system 200 during the implementation of the method steps, and FIGS. 24 and 25 are schematic views illustrating culture containers after the transfer is completed.

Referring to FIGS. 10 and 11, in initial step 302, a plurality of culture containers 100A, 100B, 100C and 100D can be respectively positioned in parallel rows in the processing regions 212, 214, 216 and 218 of the transfer system 200. Each of the culture containers 100A, 100B, 100C and 100D can be similar to the culture container 100 described previously. For example, each culture container 100A can include a tube 102A having two opposite openings respectively closed with a cover 104A and an air-permeable plug 120A. Each culture container 100B can include a tube 102B having two opposite openings respectively closed with a cover 104B and an air-permeable plug 120B. Each culture container 100C can include a tube 102C having two opposite openings respectively closed with a cover 104C and an air-permeable plug 120C. Each culture container 100D can include a tube 102D having two opposite openings respectively closed with a cover 104D and an air-permeable plug 120D.

The culture containers 100A and the culture containers 100C placed in the processing regions 212 and 216 respectively enclose an organism of interest. Examples of organisms enclosed inside the culture containers 100A and 100C may include drosophila species such as fruit flies, or any other insects that may be used as experimental models. The receptacles 106 inside the respective tubes 102A and 102C of the culture containers 100A and 100C can hold a consumable substance for the organism, and new generations of the organism, which can include, without limitation, non-adult forms of the organism such as eggs, larvae and/or pupae. The culture containers 100B and the culture containers 100D placed in the processing regions 214 and 218 are clean culture containers enclosing no organism of interest. Moreover, the receptacles 106 inside the respective tubes 102B and 102D of the culture containers 100B and 100D can hold a consumable substance for the organism of interest.

According to an embodiment, step 302 can include respectively placing the aforementioned culture containers 100A, 100B, 100C and 100D on the container carriers 222, 224, 226 and 228, and respectively positioning the container carriers 222, 224, 226 and 228 on the support base 202 in the processing regions 212, 214, 216 and 218. Each of the culture containers 100A can be placed on the container carrier 222 with the air-permeable plug 120A at a bottom of the tube 102A and received in one corresponding cavity 230 of the container carrier 222 while the cover 104A is on top of the tube 102A protruding above the container carrier 222. The other culture containers 100B, 100C and 100D can be respectively placed on the container carriers 224, 226 and 228 in a same way. The container carriers 222, 224, 226 and 228 are disposed on the support base 202 adjacent to one another so that the culture containers 100A, 100B, 100C and 100D thereon are respectively distributed in parallel rows in the processing regions 212, 214, 216 and 218.

According to some example of implementation, the placement of the culture containers 100A, 100B, 100C and 100D on the container carriers 222, 224, 226 and 228 and/or the placement of the container carriers 222, 224, 226 and 228 on the support base 202 of the transfer system 200 can be performed manually by a human operator. According to some other examples of implementation, additional equipment (e.g., including robot arms) may be provided to facilitate the placement of the culture containers 100A, 100B, 100C and 100D on the container carriers 222, 224, 226 and 228 and/or the placement of the container carriers 222, 224, 226 and 228 on the support base 202 of the transfer system 200.

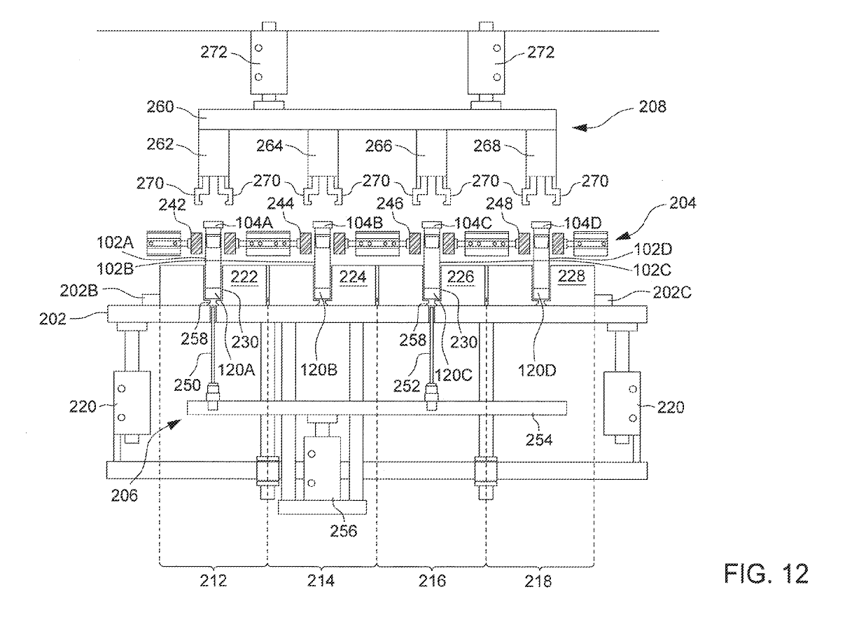

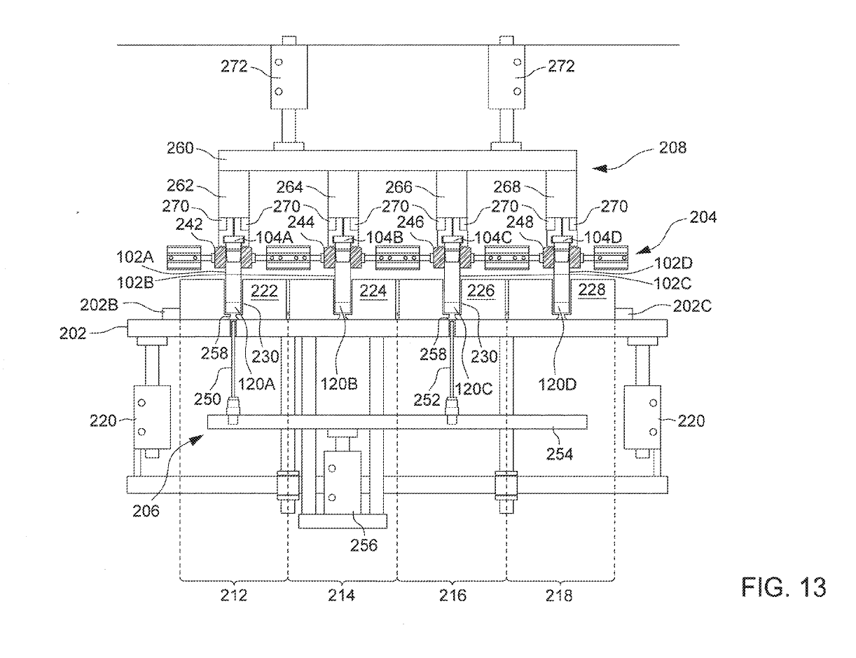

Referring to FIGS. 10, 12 and 13, the transfer system 200 in step 304 can proceed to clamp and hold the respective tubes 102A, 102B, 102C and 102D of the culture containers 100A, 100B, 100C and 100D in the processing regions 212, 214, 216 and 218, respectively. For example, as shown in FIG. 12, step 304 can include displacing the support base 202 upward so that the tubes 102A in the processing region 212 are positioned between the clamping plates 242, the tubes 102B in the processing region 214 are positioned between the clamping plates 244, the tubes 102C in the processing region 216 are positioned between the clamping plates 246, and the tubes 102D in the processing region 218 are positioned between the clamping plates 248. Then the clamping plates 242, 244, 246 and 248 of the clamping unit 204 can operate to respectively clamp and hold the tubes 102A, 102B, 102C and 102D in the processing regions 212, 214, 216 and 218. FIG. 13 illustrates the clamping plates 242, 244, 246 and 248 in the clamping state.

Referring to FIGS. 10 and 13, the cover handling unit 208 in step 306 can proceed to hold the respective covers 104A, 104B, 104C and 104D of the culture containers 100A, 100B, 100C and 100D in the processing regions 212, 214, 216 and 218. For example, the arms 262, 264, 266 and 268 can respectively move downward in the processing regions 212, 214, 216 and 218, and the fingers 270 thereof then can move to hold the respective covers 104A, 104B, 104C and 104D.

Steps 304 and 306 may be performed in parallel, or in a sequential order (e.g., the cover handling unit 208 may proceed to hold the covers 104 after the clamping unit 204 has clamped the tubes 102).

Referring to FIGS. 10, 14 and 15, the anesthetization unit 206 in step 308 can proceed to deliver an anesthetic substance into the respective tubes 102A and 102C of the culture containers 100A and 100C (i.e., enclosing the cultured organism) in the processing regions 212 and 216. For example, step 308 can include moving the nozzles 250 and 252 of the anesthetization unit 206 upward so that the nozzles 250 and 252 respectively travel through the support base 202 and the holes 258 of the container carriers 222 and 226 and then respectively insert through the air-permeable plugs 120A and 120C into the tubes 102A and 102C. Once the nozzles 250 and 252 are properly inserted, an anesthetic substance can be respectively flowed through the nozzles 250 and 252 into the tubes 102A and 102C for anesthetizing the organism enclosed in the culture containers 100A and 100C. Examples of the anesthetic substance can include, e.g., dioxide carbon gas. As a result, a portion of the anesthetized organism, in particular the adult form thereof, can drop on the air-permeable plugs 120A and 120C by gravity action. Meanwhile, a portion of the organism, including the new generations thereof, can remain in the receptacle of the covers 104A and 104C.

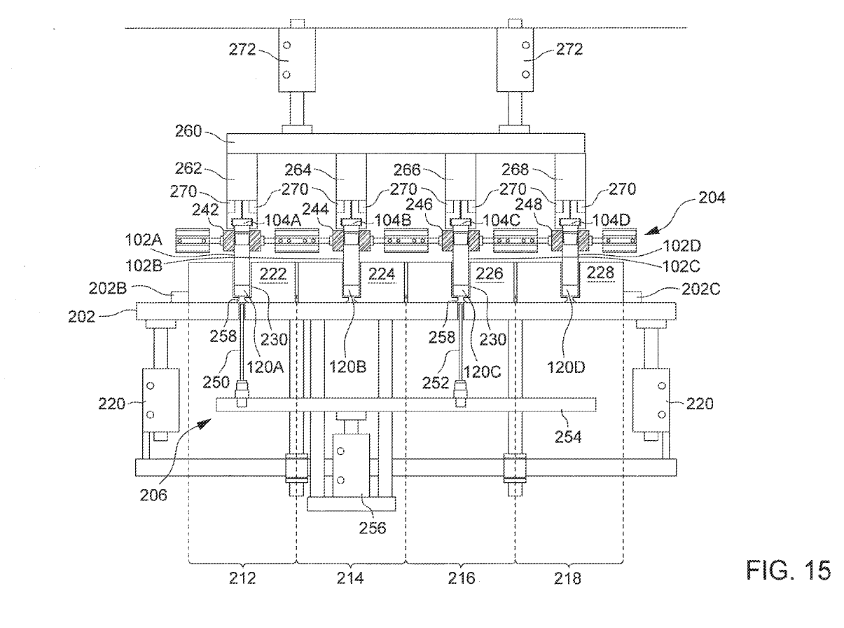

Step 308 may be performed while the clamping unit 204 respectively clamps and holds the tubes 102A, 102B, 102C and 102D in the processing regions 212, 214, 216 and 218. After the anesthetic substance is introduced into the tubes 102A and 102C, the nozzles 250 and 252 of the anesthetization unit 206 can move downward and withdraw from the tubes 102A and 102C, as shown in FIG. 15.

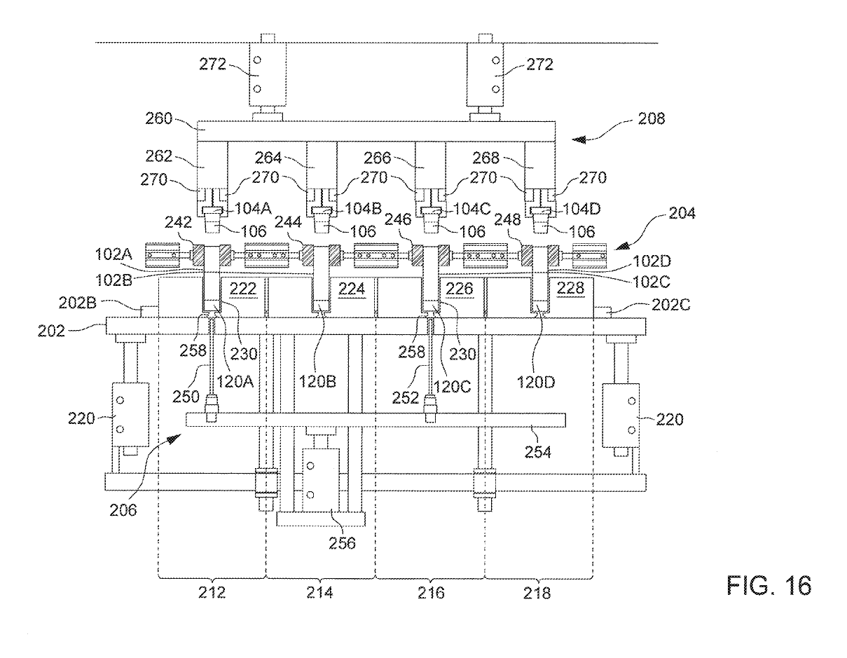

Referring to FIGS. 10 and 16, after the anesthetic substance is introduced into the tubes 102A and 102C, the cover handling unit 208 in step 310 can proceed to respectively remove the covers 104A, 104B, 104C and 104D from the tubes 102A, 102B, 102C and 102D in the processing regions 212, 214, 216 and 218. For example, while the tubes 102A, 102B, 102C and 102D are clamped by the clamping unit 204, step 310 can include moving the arms 262, 264, 266 and 268 upward with the fingers 270 thereof respectively holding the covers 104A, 104B, 104C and 104D. As a result, the covers 104A, 104B, 104C and 104D can be respectively separated from the tubes 102A, 102B, 102C and 102D.

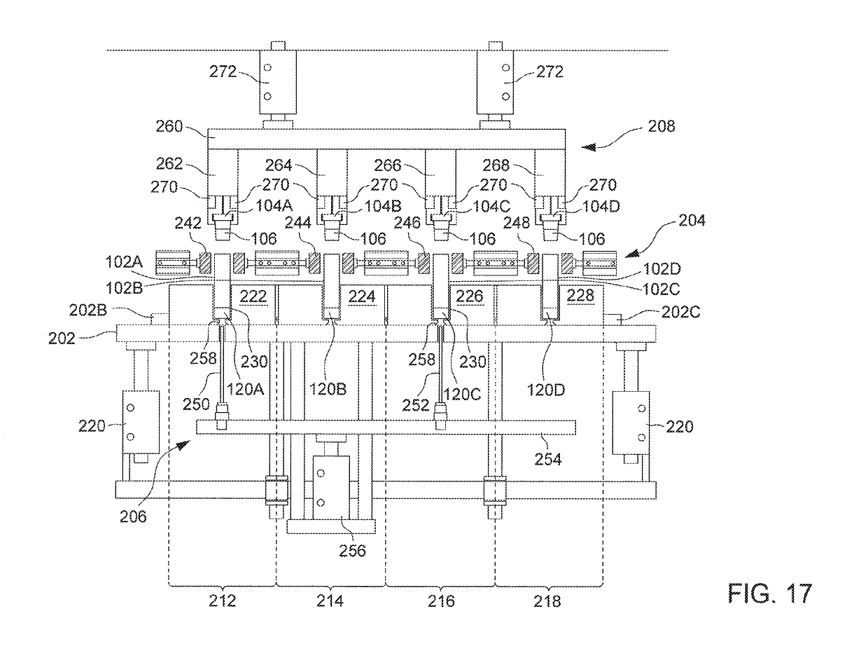

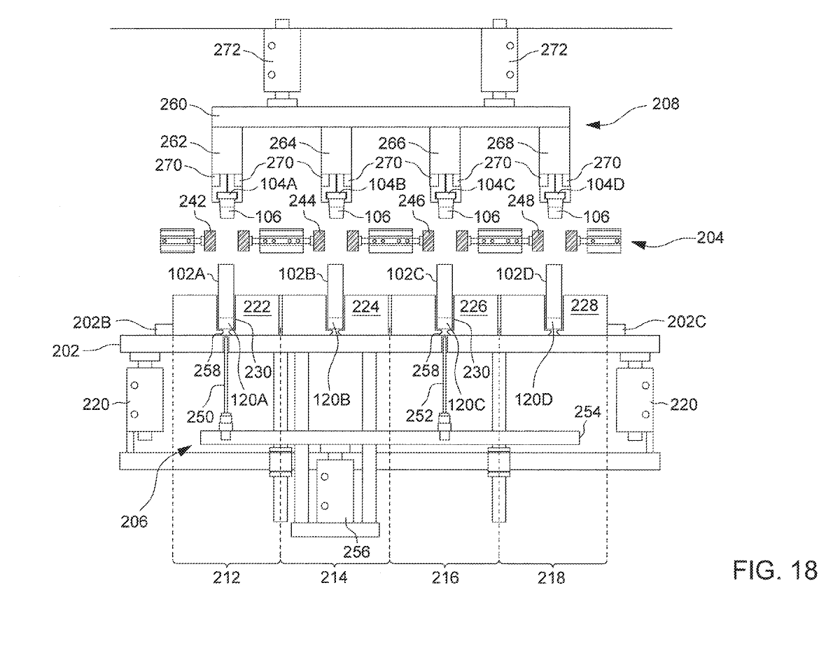

Referring to FIGS. 10, 17 and 18, in next step 312, the tubes 102A, 102B, 102C and 102D having the covers 104A, 104B, 104C and 104D removed therefrom can be released from the clamping unit 204. For example, step 312 can include moving the clamping plates 242, 244, 246 and 248 of the clamping unit 204 so as to respectively unclamp the tubes 102A, 102B, 102C and 102D in the processing regions 212, 214, 216 and 218 (as shown in FIG. 17), and then displacing the support base 202 downward so as to respectively move the tubes 102A, 102B, 102C and 102D away from the clamping plates 242, 244, 246 and 248 (as shown in FIG. 18).

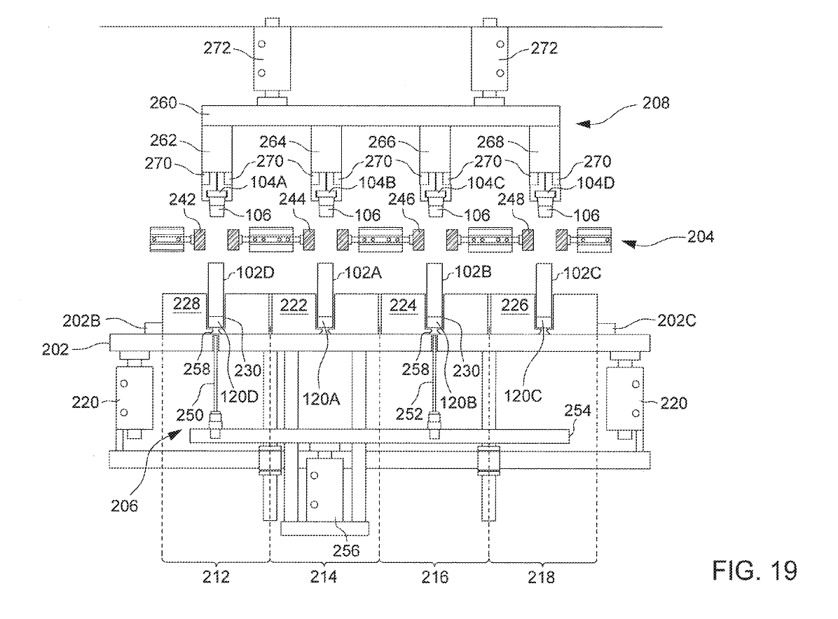

Referring to FIGS. 10 and 19, in next step 314, the tubes 102A and 102C containing a portion of the anesthetized organism fallen on the air-permeable plugs 120A and 120C are swapped with the clean tubes 102B and 102D. According to an example of implementation, the swapping step can include withdrawing the container carrier from one of the two outmost processing regions (e.g., the container carrier 222 with the tubes 102A thereon in the outmost processing region 212 or the container carrier 228 with the tubes 102D thereon in the outmost processing region 218, as shown in FIG. 18), horizontally shifting the remaining container carriers on the support base 202 toward the outmost processing region left empty by the withdrawn container carrier, and placing the withdrawn container carrier in the other outmost processing region left empty owing to the previous shifting of the container carriers on the support base 202.

For example, referring to the illustration of FIGS. 18 and 19, the container carrier 228 with the tubes 102D thereon may first be withdrawn from the processing region 218. Then all the remaining container carriers 222, 224 and 226 remaining on the support base 202 may be moved horizontally to the right so that the container carrier 222 with the tubes 102A thereon is positioned in the processing region 214, the container carrier 224 with the tubes 102B thereon is positioned in the processing region 216, and the container carrier 226 with the tubes 102C thereon is positioned in the processing region 218, the processing region 212 thereby becoming empty. Subsequently, the container carrier 228 with the tubes 102D thereon may be positioned in the processing region 212.

It will be appreciated that other swapping displacements may be applied between the tubes 102A and 102C containing a portion of the anesthetized organism and the clean tubes 102B and 102D. For example, another swapping movement may include permuting the container carriers in each pair of adjacent processing regions: the container carrier 222 with the tubes 102A thereon may be displaced on the support base 202 so as to be positioned in the processing region 214, the container carrier 224 with the tubes 102B thereon may be displaced on the support base 202 so as to be positioned in the processing region 212, the container carrier 226 with the tubes 102C thereon may be displaced on the support base 202 so as to be positioned in the processing region 218, and the container carrier 228 with the tubes 102D thereon may be displaced on the support base 202 so as to be positioned in the processing region 216.

According to an example of implementation, the aforementioned swapping step may be performed manually by a human operator. In some other examples of implementation, additional equipment (e.g., including robot arms) may be provided to facilitate swapping of the tubes. This swapping operation may be performed while the cover handling unit 208 respectively keeps the covers 104A, 104B, 104C and 104D in the processing regions 212, 214, 216 and 218.

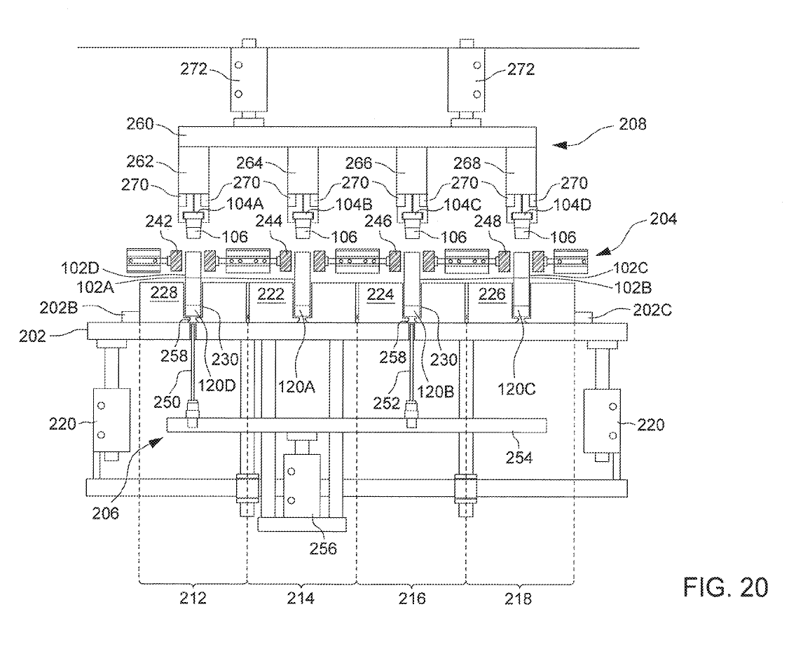

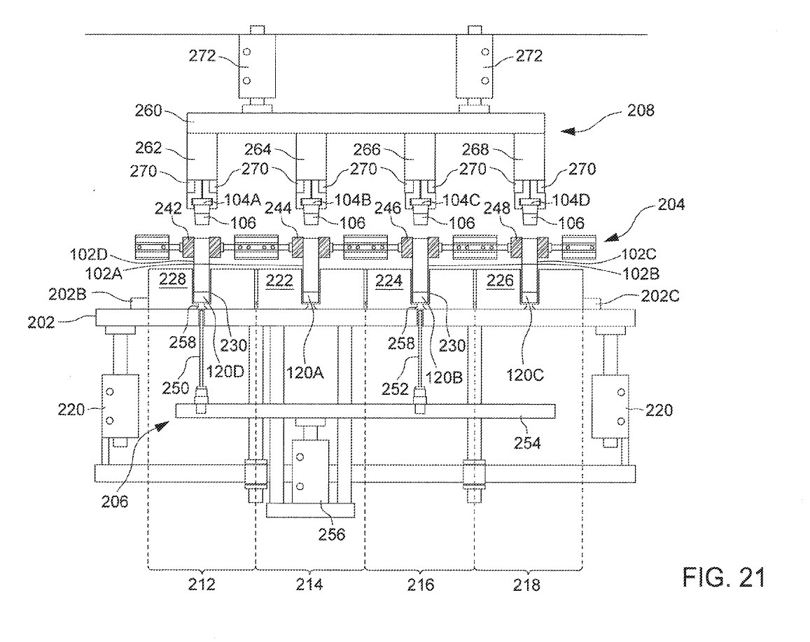

Referring to FIGS. 10, 20 and 21, the transfer system 200 in following step 316 can proceed to clamp and hold the swapped tubes 102D, 102A, 102B and 102C respectively in the processing regions 212, 214, 216 and 218. For example, as shown in FIG. 20, step 316 can include displacing the support base 202 upward so that the tubes 102D in the processing region 212 are positioned between the clamping plates 242, the tubes 102A in the processing region 214 are positioned between the clamping plates 244, the tubes 102B in the processing region 216 are positioned between the clamping plates 246, and the tubes 102C in the processing region 218 are positioned between the clamping plates 248. Then the clamping plates 242, 244, 246 and 248 of the clamping unit 204 can operate to respectively clamp and hold the tubes 102D, 102A, 102B and 102C in the processing regions 212, 214, 216 and 218. FIG. 21 illustrates the clamping plates 242, 244, 246 and 248 in this clamping state.

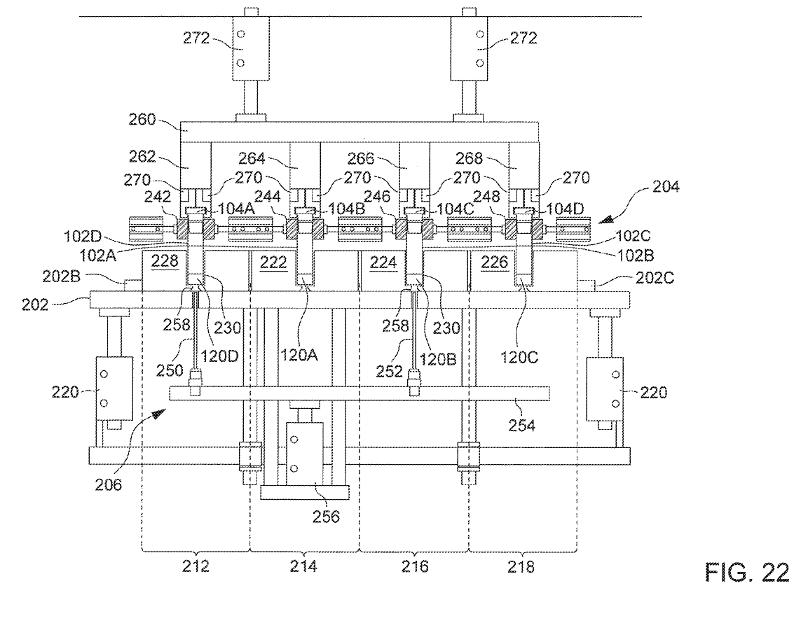

Referring to FIGS. 10 and 22, the cover handling unit 208 in step 318 can proceed to respectively close the swapped tubes 102D, 102A, 102B and 102C with the covers 104A, 104B, 104C and 104D in the processing regions 212, 214, 216 and 218. For example, while the tubes 102D, 102A, 102B and 102C are respectively clamped by the clamping unit 204 in the processing regions 212, 214, 216 and 218, step 318 can include moving the arms 262, 264, 266 and 268 downward with the fingers 270 thereof respectively holding the covers 104A, 104B, 104C and 104D. As a result, the covers 104A, 104B, 104C and 104D can be respectively installed to close the tubes 102D, 102A, 102B and 102C. After the covers 104A, 104B, 104C and 104D are respectively put in place on the tubes 102D, 102A, 102B and 102C, the fingers 270 can release the covers and the arms 262, 264, 266 and 268 can move upward.

The tubes 102D with the covers 104A thereon can respectively form a plurality of culture containers 100D′, the tubes 102A with the covers 104B thereon can respectively form a plurality of culture containers 100A′, the tubes 102B with the covers 104C thereon can respectively form a plurality of culture containers 100B′, and the tubes 102C with the covers 104D thereon can respectively form a plurality of culture containers 100C′. FIG. 24 illustrates an example of one culture container 100A′ or 100C′, and FIG. 25 illustrates an example of one culture container 100B′ or 100D′. Referring to FIG. 24, in the culture container 100A′ or 100C′, the organism of interest T (mostly the adult form thereof) can remain temporarily stunned on the air-permeable plug 120A or 120C. A consumable substance 122 held in the receptacle 106 of the cover 104B or 104D can be used to continue culturing the organism of interest T inside the culture container 100A′ or 100C′. Referring to FIG. 25, in the culture container 100B′ or 100D′, the receptacle 106 of the cover 104C or 104A can hold the new generations T′ of the organism of interest, which can include the non-adult form of the organism such as eggs, larvae and/or pupae.

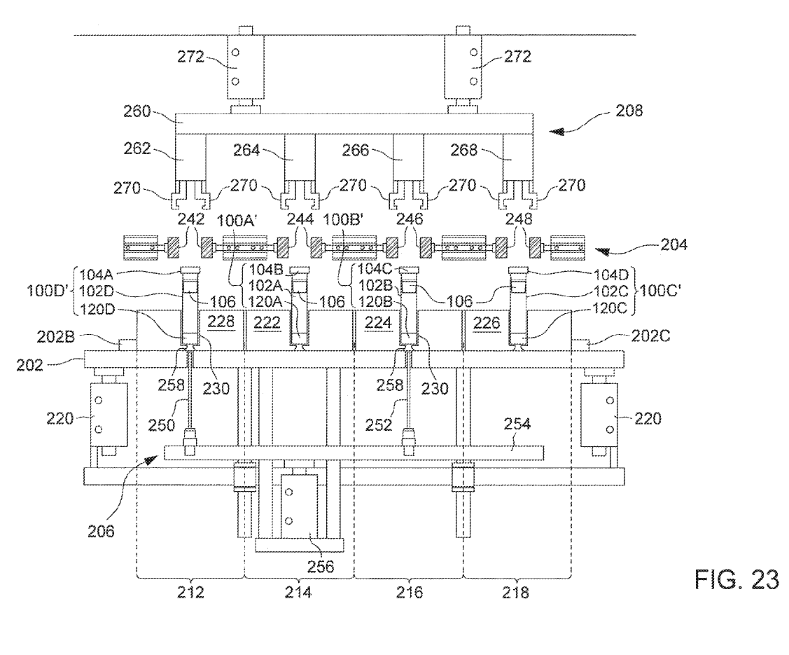

Referring to FIGS. 10 and 23, the transfer system 200 in step 320 can proceed to unclamp and release the culture containers 100D′, 100A′, 100B′ and 100C′ in the processing regions 212, 214, 216 and 218. For example, step 320 can include moving the clamping plates 242, 244, 246 and 248 of the clamping unit 204 so as to respectively unclamp the tubes 102D, 102A, 102B and 102C in the processing regions 212, 214, 216 and 218, and then displacing the support base 202 downward so as to respectively move the tubes 102D, 102A, 102B and 102C away from the clamping plates 242, 244, 246 and 248.

New generations of the organism of interest can be thereby grown and maintained in the culture containers 100B′ and 100D′, whereas the culture containers 100A′ and 100C′ can be kept as backup stocks. The culture containers 100A′, 100B′, 100C′ and 100D′ may be turned over so that the respective covers 104 thereof are at the bottom for culturing the organism of interest.

Advantages of the culture containers, systems and method described herein include the ability to culture and transfer large stocks of an organism of interest in an efficient manner. Rather than transferring the organism itself, the systems and method described herein transfer a cover of the culture container that can hold new generations of the organism of interest, which can greatly facilitate the transfer operation.

Realizations of the structures and methods have been described only in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the claims that follow.

What is claimed is:

1. A transfer system comprising:
a first and a second processing region;
a support base suitable to provide support for a plurality of culture containers positioned in the first and second processing regions, each of the culture containers including a tube having a first and a second opening at two opposite ends thereof and a removable cover installable to close the first opening of the tube, the first and second processing regions being adapted to interchangeably receive the tubes of the culture containers;
an anesthetization unit operable to deliver an anesthetic substance into at least one culture container positioned in the first processing region; and
a cover handling unit operable to separate the covers from the tubes and close the first openings of the tubes with the covers in the first and second processing regions.

2. The transfer system according to claim 1, wherein the cover handling unit is disposed vertically above the anesthetization unit.

3. The transfer system according to claim 1, wherein the anesthetization unit is operable to deliver an anesthetic substance from an underside of the support base into at least one culture container positioned in the first processing region.

4. The transfer system according to claim 1, wherein the anesthetization unit is operable to concurrently deliver an anesthetic substance into a plurality of culture containers disposed in a row in the first processing region.

5. The transfer system according to claim 1, further comprising a clamping unit operable to hold and release the tubes of the culture containers in the first and second processing regions.

6. The transfer system according to claim 5, wherein the anesthetization unit is operable to deliver an anesthetic substance into the culture containers that are positioned in the first processing region while the tubes of all the culture containers in both the first and second processing regions are held by the clamping unit.

7. The transfer system according to claim 5, wherein the support base is adapted to provide support for a plurality of culture containers respectively disposed along two parallel rows in the first and second processing regions, each of the culture containers including a tube having a first and a second opening at two opposite ends thereof and a removable cover installable to close the first opening of the tube, and the clamping unit is operable to hold the tubes of the culture containers respectively disposed along the two parallel rows in the first and second processing regions.

8. The transfer system according to claim 1, wherein the support base is adapted to provide support for a plurality of culture containers disposed along two parallel rows in the first and second processing regions, each of the culture containers including a tube having a first and a second opening at two opposite ends thereof and a removable cover installable to close the first opening of the tube, and the cover handling unit is operable to concurrently separate the covers from the tubes along the two parallel rows in the first and second processing regions, and to concurrently close the tubes with the covers along the two parallel rows in the first and second processing regions.

9. The transfer system according to claim 1, further comprising:
at least two container carriers, each of the two container carriers respectively having a row of cavities adapted to receive a plurality of culture containers, each of the culture containers including a tube having a first and a second opening at two opposite ends thereof and a removable cover closing the first opening of the tube;
wherein the two container carriers are interchangeably positionable in the first and second processing regions.

10. The transfer system according to claim 9, wherein the support base has a plurality of stop structures for assisting with positioning of the two container carriers in the first and second processing regions.

11. The transfer system according to claim 9, wherein the support base is movable along a vertical axis.

12. The transfer system according to claim 9, wherein at least one of the two container carriers has a bottom surface provided with a plurality of holes respectively connected with the cavities thereof.

13. The transfer system according to claim 12, wherein the anesthetization unit includes a plurality of nozzles, the nozzles being movable through the support base and the holes of the container carrier positioned in the first processing region for delivering an anesthetic substance into a plurality of culture containers carried by the container carrier in the first processing region.

14. A method of transferring a cultured organism through a transfer system that includes an anesthetization unit and a cover handling unit, the method comprising:
positioning a first culture container enclosing an organism of interest in a first processing region of the transfer system, wherein the first culture container includes a first tube having two openings at two opposite ends thereof, and a first cover and a first air-permeable plug respectively closing the two openings of the first tube, the first cover including a first receptacle holding a substance consumable by the organism and new generations of the organism, the first receptacle being enclosed inside the first tube;
positioning a second culture container enclosing no organism of interest in a second processing region of the transfer system, wherein the second culture container includes a second tube having two openings at two opposite ends thereof, and a second cover and a second air-permeable plug respectively closing the two openings of the second tube, the second cover including a second receptacle holding a substance consumable by the organism, the second receptacle being enclosed inside the second tube;
delivering an anesthetic substance into the first tube with the anesthetization unit;
respectively removing the first cover from the first tube and the second cover from the second tube with the cover handling unit;
swapping the first tube having the first cover removed therefrom with the second tube having the second cover removed therefrom so that the first tube is positioned in the second processing region and the second tube is positioned in the first processing region; and
through the cover handling unit, closing the first tube in the second processing region with the second cover, and closing the second tube in the first processing region with the first cover.

15. The method according to claim 14, wherein the transfer system further includes a clamping unit, and the step of delivering an anesthetic substance into the first tube is performed while the clamping unit respectively clamps and holds the first and second tubes in the first and second processing regions.

16. The method according to claim 14, wherein the step of positioning a first culture container enclosing an organism of interest in a first processing region of the transfer system comprises placing the first culture container on a first container carrier and positioning the first container carrier in the first processing region, and the step of positioning a second culture container in a second processing region of the transfer system comprises placing the second culture container on a second container carrier and positioning the second container carrier in the second processing region.

17. The method according to claim 16, wherein the step of swapping the first tube having the first cover removed therefrom with the second tube having the second cover removed therefrom comprises positioning the first container carrier with the first tube thereon in the second processing region, and positioning the second container carrier with the second tube thereon in the first processing region.

18. The method according to claim 16, wherein the first culture container is placed on the first container carrier with the first air-permeable plug at a bottom of the first tube and the first cover at a top of the first tube, and the second culture container is placed on the second container carrier with the second air-permeable plug at a bottom of the second tube and the second cover at a top of the second tube.

19. The method according to claim 16, wherein the step of delivering an anesthetic substance into the first tube comprises inserting a nozzle of the anesthetization unit through the first air-permeable plug and delivering the anesthetic substance into the first tube via the nozzle.

20. The method according to claim 14, wherein the step of swapping the first tube having the first cover removed therefrom with the second tube having the second cover removed therefrom is performed while the first and second covers are respectively kept in the first and second processing regions.
